(19) United States
(12) Patent Application Publication
(10) Pub. No.: US 2006/0075240 A1
(43) Pub. Date: Apr. 6, 2006

(54) Lossless data embedding

(76) Inventors: Antonius Adrianus Cornelis Maria Kalker, Eindhoven (NL); Franciscus Maria Joannes Willems, Geldrop (NL)

Correspondence Address: PHILIPS INTELLECTUAL PROPERTY & STANDARDS, P.O. BOX 3001, BRIARCLIFF MANOR, NY, 10510, US

(21) Appl. No.: 10/542,894

(22) PCT Filed: Jan. 23, 2004
(86) PCT No.: PCT/IB04/50050

§ 371 Date: Jul. 20, 2005

(30) Foreign Application Priority Data
Jan. 23, 2003 (EP) 03075226.5

(51) Int. Cl. H04L 9/00

(52) U.S. Cl. 713/176

(57) ABSTRACT

Many methods for reversible watermarking (embedding schemes that allow perfect reconstruction of the original host signal) are highly fragile in the sense that the slightest modification of watermarked content prohibits the recovery of both the original signal as well as the embedded auxiliary data. In order to obtain robustness against transmission or channel errors, the embedding method according to the invention accommodates error correction data in a portion of the data embedding capacity. In an advantageous embodiment, the host signal (36) is segmented in segments, and error correction data (p(n)) for a segment (S(n)) is accommodated in data (37) being embedded in a subsequent segment (S(n+1)) along with restoration data (r(n)) for reconstructing the host signal. The remaining portion of the embedding capacity is used for payload (w).

### FIELD OF THE INVENTION

The invention relates to a method of embedding auxiliary data in a host signal, comprising the steps of using a data embedding method having an embedding rate and distortion to produce a composite signal, and using a first portion of said embedding rate to accommodate restoration data for restoring the host signal and a second portion of said embedding rate for embedding said auxiliary data. The invention also relates to a corresponding arrangement for embedding auxiliary data in a host signal.

The invention further relates to a method and arrangement for reconstructing such a host signal, and to a composition information signal with embedded data.

### BACKGROUND OF THE INVENTION

An undesirable side effect of many watermarking and data-hiding schemes is that the host signal into which auxiliary data is embedded is distorted. Finding an optimal balance between the amount of information embedded and the induced distortion is therefore an active field of research. In recent years, there has been considerable progress in understanding the fundamental limits of the capacity versus distortion of watermarking and data-hiding schemes. For some applications, however, no distortion resulting from auxiliary data, however small, is allowed. In these cases the use of reversible data-hiding methods provides a way out. A reversible data-hiding scheme is defined as a scheme that allows complete and blind restoration (i.e. without additional signaling) of the original host data.

A reversible data-hiding method as defined in the opening paragraph is disclosed in J. Fridrich, M. Goljan, and R. Du, “Lossless Data Embedding For All Image Formats”, Proceedings of SPIE, Security and Watermarking of Multimedia Contents, San Jose, 2000, but little attention has been paid to the theoretical limits. In this Fridrich et al. paper, a subset B of features of a signal X (e.g. a certain bit plane of a bitmap image, or the least significant bits of specific DCT coefficients of a JPEG image) is derived such that (i) B can be losslessly compressed, and such that (ii) randomization of B has little impact. Lossless data-hiding is then achieved by lossless compression of B, concatenating the bitstream with auxiliary data and replacing the original set B.

In T. Kalker and F. Willems, “Capacity Bounds And Constructions For Reversible Data-Hiding”, Proceedings of the International Conference on Digital Signal Processing”, 1, pp. 71-76, June 2002, some first results on the capacity of reversible watermarking schemes have been derived. In this paper, Kalker et al. use a predetermined embedder having a given embedding rate and distortion. They have shown that the embedding capacity can be increased by embedding in the host signal restoration data that identifies the host signal conditioned on the composite signal. This is understood to mean that the restoration data defines, given the composite signal, which host signal samples have undergone which modification by the embedding process. In practical embodiments, Kalker et al. divide the host signal in segments, embed the restoration data for such a segment in a subsequent segment, and use the remaining portion of the embedding rate for embedding auxiliary data. Such a reversible data-hiding scheme is referred to as “recursive” reversible embedding. The present invention also addresses such a recursive reversible embedding scheme.

A problem of reversible embedding schemes including the recursive reversible embedding scheme of Kalker et al. is that they have a highly fragile nature. Changing a single bit in the watermarked data prohibits recovery of both the original host signal as well as the embedded auxiliary data. This puts a severe limitation on the usability of reversible watermarking schemes. Only in a context in which an owner has complete control over the watermarked data (e.g. archives) or in the context of authentication do these watermarking schemes have a useful application.

### OBJECT AND SUMMARY OF THE INVENTION

It is an object of the invention to provide an improved reversible data embedding method and arrangement, as well as corresponding method and arrangement for reconstructing the original host signal.

According to a first aspect of the invention, a method is provided as defined in claim 1. The invention exploits the insight that a portion of the embedding capacity of a reversible embedding scheme can be used for error protection of the payload as well as the host signal carrying said payload. The embedding scheme is thus robust with respect to channel errors.

It should be noted that it is known per se from U.S. patent application US 2003/0009670, in particular paragraph [0419] thereof, to embed error correction data in a watermarked host signal. However, in this publication the error correction data protects the watermark payload only.

According to further aspects of the invention, defined in further independent claim 2, error correction data for a given segment of the composite signal is embedded in a subsequent segment of the host signal. In this way a robust recursive reversible embedding scheme is obtained with a high embedding rate. It is a particular advantage of the invention that the error correction data can be processed in a manner which is compatible with the processing of other data.

### BRIEF DESCRIPTION OF THE DRAWINGS

FIG. 1 shows schematically a system including an arrangement for embedding auxiliary data in a host signal and an arrangement for reconstructing the host signal according to the invention.

FIG. 2 shows schematically an embodiment of an embedding arrangement which is shown in FIG. 1.

FIGS. 3 and 4 show practical examples of dividing the host signal into segments in accordance with preferred embodiments of the invention.

FIG. 5 shows schematically an embodiment of an arrangement for reconstructing the host signal which is shown in FIG. 1.

### DESCRIPTION OF EMBODIMENTS

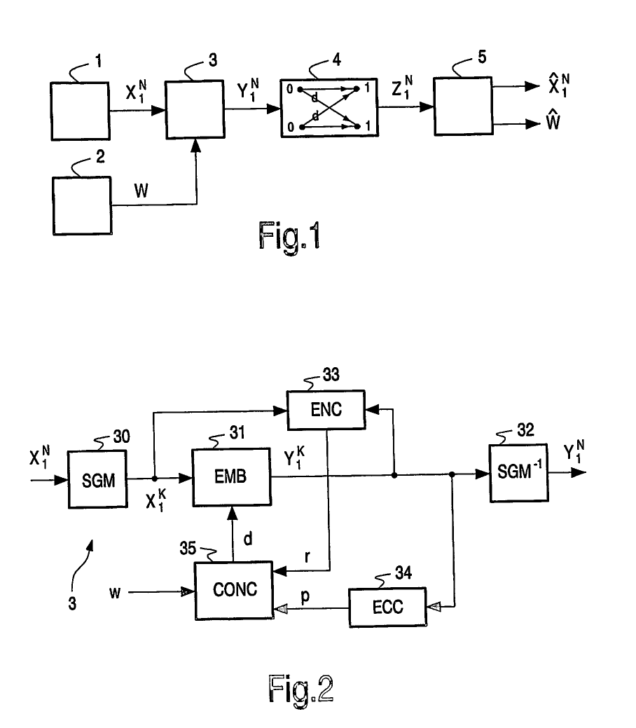

FIG. 1 shows schematically a system including an embedding arrangement 3 for embedding auxiliary data in a host signal and a reconstructing arrangement 5 for reconstructing the host signal according to the invention. The system comprises a discrete memoryless 1 source that produces a host sequence x₁^{N}=x₁x₂ . . . x_{N} of symbols from a discrete alphabet. In a preferred embodiment, the source 1 is a binary source, the symbols xᵢ of which are, for example, the bits of a certain bit plane of a bit mapped image, or the least significant bits of specific DCT coefficients of a JPEG image. The invention, however, is not restricted to binary sources.

A auxiliary data or message source 2 produces a message index or message symbols wε (1,2, . . . ,M} with probability 1/M, independent of x₁^{N}. The embedding arrangement 3 embeds the message w into the host sequence x₁^{N} and forms a composite signal sequence y₁^{N}=y₁y₂ . . . y_{N} of symbols. We require that the sequence y₁^{N} must be close to x₁^{N}, i.e. the average distortion should be small for some specific distortion measure D. The embedding-rate R, in bits per source-symbol, is defined as

$$R = \frac{1}{N} {log}_{2} ( M )$$

The composite sequence is sent through a memoryless attack channel 4 with transition probability matrix Q(•|•) to produce a degraded version z₁^{N} of the watermarked sequence y₁^{N}. The word attack channel is somewhat of a misnomer, as it suggests the presence of an active and intelligent attacker. However, in this description no such connotation is intended and the word ‘attack’ is only chosen to reflect common terminology in watermarking literature. The reconstructing arrangement 5 produces an estimate of the host sequence x₁^{N}, and retrieves the embedded message w, from the composite sequence z₁^{N}.

Although the invention is not restricted to binary sources, we will now consider a memoryless binary source 1 with alphabet xᵢ={0,1}, and use Hamming distance as distortion measure. Let p₁=Pr{xᵢ=1} and p₀=Pr{xᵢ=0}=1−p₁. Let the attack channel 4 be given as a binary symmetric channel with 0→1 transition probability equal to d. In this case it is theoretically and asymptotically easy to construct a robust reversible data-hiding scheme with distortion Dₐᵥ=0.5.

There are a number of possibilities for extending fragile reversible watermarking to robust reversible watermarking. Firstly, robustness can refer to robustness of the watermark payload, i.e. the channel degradations do not interfere with payload recovery. Secondly, robustness can refer to the reversibility aspect, i.e. the original host signal can still be recovered after channel degradations. This second option can be further detailed with respect to the degree with which the original can be restored. At one extreme the original is completely recoverable; at the other extreme the original can only be retrieved up to a distortion that is compatible with the channel degradations. Thirdly and finally, robustness can refer to both payload and reversibility. The first and second option have limited applicability, as one of two the desirable properties of reversible watermarking is lost (payload or reversibility). The invention focusses on the third option, where robustness refers to both to the payload and the reversibility aspect

In accordance with the teaching of Fridrich et al., a string of host signal symbols x₁^{N} of length N is compressed into a string y₁^{K} of length K, where K is approximately equal to N×h(p₁), where h(•) denotes binary entropy. Note that this may be applied to the whole sequence x₁^{N}, or to successive segments x₁^{N} into which the sequence may have been divided. The compression leaves N−K bits space available for adding additional bits. In accordance with the invention, robustness against transmission or channel errors is now obtained by accommodating error correction bits in a portion of this space. For N large, the number of errors to be corrected is d×N. It is quite easy to show that there exist error correcting codes such that the number of parity check bits that have to be added is equal to N×h(d). The remaining portion can be filled with auxiliary (message) data bits w. Let the number of auxiliary data bits that can be added be denoted by R(p₁,d)×N, where R(p₁,d) denotes the embedding rate. The embedding rate of this “simple” robust embedding scheme then follows from:
N×h(p₁)+N×h(d)+N×R(p₁,d)=N, or
R(pᵢ,d)=1−h(p₁)−h(d)
Obviously, the robustness cannot be achieved for attack channels for which h(d)>1−h(p1).

The associated decoding procedure is a simple inversion of the embedding procedure. Firstly, the degraded sequence z₁^{N} is subjected to error correcting decoding. Secondly, the corrected sequence minus error correction data is decompressed until a sequence of length N is obtained. The remaining bits are then automatically obtained as auxiliary message bits.

The above-decribed embedding scheme can be slightly generalized by performing the construction above on only a fraction α of the symbols in x₁^{N}. This is often referred to as “time-sharing”. The resulting distortion and information rate are then given by
Dₐᵥ=α/2 and
R(p₁,d)=α(1−h(p₁))−h(d).
In other words, asymptotically we can achieve a rate-distortion function R(D):
R(D)=2D(1−h(p₁))−h(d) (1)
whenever the righthand side of the equation is positive. It is to be noted that in this time-sharing construction the parity check bits for the total string are to be encoded in the fraction that is being compressed. Apart from the inclusion of parity check bits, this method of robust reversible data-hiding is essentially the same method as proposed by Fridrich et al.

Kalker et al. showed that for an error-free channel 4 the Fridrich et al. scheme is not optimal. The inventors have now found that also for robust embedding the result as given in equation (1) is not optimal.

FIG. 2 shows an embodiment of embedding arrangement 3 that is robust against transmission or channel errors, and has a higher embedding rate. Apart from an error correction coding circuit 35, the arrangement complies with the teaching of the Kalker et al. publication. Its operation has more exhaustively been described in Applicant's non-prepublished International patent application WO 03/107653 and will now briefly be summarized.

The arrangement comprises a segmentation stage 30 which divides the host signal sequence x₁^{N} of length N in segments x₁^{K} of length K. It will initially be assumed that all segments have the same length K, but an embodiment will later be described in which the segments have different lengths. It will also again be assumed that the host signal X is a binary signal with alphabet {0,1}.

The arrangement further comprises a data embedder 31, which is conventional in the sense that the embedder embeds payload d at a given embedding rate by modifying samples of the host signal and thus introducing distortion of the host signal. The embedder 31 produces a composite signal segment Y₁^{K} for each host signal segment X₁^{K}. A desegmentation circuit 32 concatenates the segments to form the composite signal sequence Y₁^{N}.

In a preferred embodiment of the arrangement, the embedder 31 operates in accordance with the teachings of an article by M. van Dijk and F. M. J. Willems, “Embedding Information in Grayscale Images”, Proceedings of the 22^{nd} Symposium on Information Theory in the Benelux, Enschede, The Netherlands, May 15-16, 2001, pp. 147-154. In this article, the authors describe lossy embedding schemes that have an efficient rate-distortion ratio. More particularly, a number L (L>1) of host signal samples are grouped together to provide a block or vector of host symbols. In order to embed a message symbol d in a block X₁^{L} of L host symbols, the embedder modifies one or more host symbols of said block such that the syndrome of output block Y₁^{L} represents the desired message symbol d and is closest to X₁^{L} in a Hamming sense. The syndrome of a data word or vector is the result of multiplying it with a given matrix.

To illustrate this, data embedding using a Hamming code with block length L=3 will now be briefly summarized. This code allows 2 bits to be embedded in a block (R=⅔ bits/symbol). Note that all mathematical operations are modulo-2 operations.

To compute the syndrome of a block or vector of 3 bits, the vector is multiplied with the following 3×2 matrix:

$$[ \begin{matrix}0 & 1 & 1 \\ 1 & 0 & 1\end{matrix} ]$$

For example, the syndrome of input vector (001) is (11), because

$$[ \begin{matrix}0 & 1 & 1 \\ 1 & 0 & 1\end{matrix} ] \times [ \begin{matrix}0 \\ 0 \\ 1\end{matrix} ] = [ \begin{matrix}1 \\ 1\end{matrix} ]$$

It is this syndrome (11) which represents the embedded data. Obviously, the syndrome of a host vector is generally not equal to the message to be embedded. One of the host symbols must therefore often be modified. If, for example, the message (01) is to be embedded instead of (11), the embedder 23 changes the second host symbol so that original host vector (001) is modified into (011):

$$[ \begin{matrix}0 & 1 & 1 \\ 1 & 0 & 1\end{matrix} ] \times [ \begin{matrix}0 \\ 1 \\ 1\end{matrix} ] = [ \begin{matrix}0 \\ 1\end{matrix} ]$$

The “squared error” is often used to represent distortion:
D(x,y)=(x−x)²
The distortion of this embedding scheme per 3 symbols is

$$\frac{1}{4} \cdot {0}^{2} + \frac{3}{4} \cdot {1}^{2} = \frac{3}{4}$$

(probability ¼ that none of the host symbols is changed and probability ¾ that one symbol is changed by ±1), so that the average distortion per symbol is DI=¼. The embedding rate is 2 bits per block, i.e. R=⅔ bits/symbol.

In a similar manner, 3 data bits can be embedded in a block of 7 signal symbols, 4 bits can be embedded in 15 signal symbols, etc. More generally, the Hamming code based embedding schemes allow m message symbols to be embedded in blocks of L=2^{m}−1 host symbols by modifying at most 1 host symbol. The embedding rate is

$$R = \frac{m}{{2}^{m} - 1} , \qquad ( 2 )$$

and the distortion is

$$D = \frac{1}{{2}^{m}} . \qquad ( 3 )$$

In order to be able to reconstruct the original host signal X₁^{N}, a restoration encoder 33 receives each host signal segment X₁^{K} and the composite signal Y₁^{K}. The restoration encoder encodes X₁^{K} conditioned on Y₁^{K}, what can also be expressed as X₁^{K} given Y₁^{K}. In fact, the encoder 33 maintains a record of which host symbols have undergone which modification and encodes said information into restoration data r. The expression “which host symbols have undergone which modification” must be interpreted broadly. If the distortion is either D=0 or D=1 (which is the case in this embodiment), then it suffices to identify which symbols have undergone distortion. For other types of embedder 31, the amount of distortion must be encoded as well. It can be shown that the restoration data rate in bits/symbol is smaller than the embedding rate of embedder 31.

It should be noted that the restoration encoder 33 represents a functional feature of the invention. The circuit does not need to be physically present as such. In the practical embodiment of the arrangement being presented hereinafter, the information as to which symbols have been distorted is inherently produced by the embedder 31 itself.

In the present example, a portion of the embedding capacity is used to identify whether one of the signal samples has been modified and, if so, which sample that is. For the Hamming codes with block length 3 (m=2, L=3), there are 4 possibilities: none of the three host symbols has been changed, the first symbol has been modified, the second symbol has been modified, or the third symbol has been modified. If the entropy H(p) of the host signal source is equal to 1, then all events have equal probabilities. In that case, both embedded message bits per block are required for restoration. However, if the entropy H(p) of the signal source is unequal to 1, then the events have different probabilities, and less than m restoration bits are required. This leaves space to embed further data in the host signal.

Let it be assumed that p₀=0.9. Accordingly, the probability p(x=000) that the source produces host vector (000) is (0.9)³≈0.729. The probability p(x=001) that the source produces host vector (001) is (0.9)²×(0.1)≈0.081, etc. Assume that the embedder 31 of the arrangement has produced a composite vector y=000. The original host vector x could have been (000). In that case, none of the original signal samples has been modified. However, the original host vector could also have been (001), (010), or (100). In that case, one of the host symbols has been modified. The probability that the host vector was x=000, given y=000, is:

$$p ( x = 000 \vert y = 000 ) = \frac{p ( x = 000 )}{p ( x = 000 ) + p ( x = 001 ) + p ( x = 010 ) + p ( x = 100 )} = 0.75$$

In a similar manner, the probabilities that y=000 originates from host vector (001), (010) or (100) can be computed. This yields:
p(x=001|y=000)=0.083
p(x=010|y=000)=0.083
p(x=100|y=000)=0.083

Each composite vector y has thus an associated set of conditional probabilities p(x|y). They are summarized in the following Table. The Table also includes, for each block y, the corresponding conditional entropy H(x|y). Said conditional entropy represents the 10 uncertainty of original vector x, given the vector y. The Table also includes, for each vector y, the probability p(y), assuming that the messages 00, 01, 10 and 11 have equal probabilities ¼. For example, the probability p(y=000) has been computed as follows:

$\begin{matrix}p ( y = 000 ) = \frac{1}{4} p ( x = 000 ) + \frac{1}{4} p ( x = 001 ) + \frac{1}{4} p ( x = 010 ) + \\ \frac{1}{4} p ( x = 100 ) = 0.2430\end{matrix}$

| | | | p(x\|y) | | | | | | | |
|---|---|---|---|---|---|---|---|---|---|---|
| x | syndrome | p(x) y = 000 | y = 001 | y = 010 | y = 011 | y = 100 | y = 101 | y = 110 | y = 111 | |
| 000 | 00 | 0.729 | 0.7500 | 0.8804 | 0.8804 | | 0.8804 | | | |
| 001 | 11 | 0.081 | 0.0833 | 0.0978 | | 0.4709 | | 0.4709 | | |
| 010 | 10 | 0.081 | 0.0833 | | 0.0978 | 0.4709 | | | 0.4709 | |
| 011 | 01 | 0.009 | | 0.0109 | 0.0109 | 0.0523 | | | | 0.3214 |
| 100 | 01 | 0.081 | 0.0833 | | | | 0.0978 | 0.4709 | 0.4709 | |
| 101 | 10 | 0.009 | | 0.0109 | | | 0.0109 | 0.0523 | | 0.3214 |
| 110 | 11 | 0.009 | | | 0.0109 | | 0.0109 | | 0.0523 | 0.3214 |
| 111 | 00 | 0.001 | | | | 0.0058 | | 0.0058 | 0.0058 | 0.0357 |
| | | H(x\|y) = | 1.2075 | 0.6316 | 0.6316 | 1.2891 | 0.6316 | 1.2891 | 1.2891 | 1.7506 |
| | | p(y) = | 0.2430 | 0.2070 | 0.2070 | 0.0430 | 0.2070 | 0.0430 | 0.0430 | 0.0070 |

The conditional entropy H(X|Y) of the source, averaged over all blocks y, represents the number of bits to reconstruct x, given y. In the present example, said average entropy equals:

$$H ( X \vert Y ) = {\sum }_{y} p ( y ) H ( x \vert y ) = 0.8642 bits \text{/} block$$

Accordingly, 0.8642 restoration bits per block are required to identify the original block. This leaves 2−0.8642=1.1358 bits/block for embedding further data If this capacity is used for embedding payload, the data rate R is thus:

$$R = \frac{1.1358}{3} = 0.3786 bits \text{/} symbol .$$

Note that the distortion D of the composite signal is not affected by the particular meaning that has now been assigned to the embedded data d. As described before, the distortion of this lossless embedding scheme is D=¼.

In accordance with the invention, a portion of the remaining embedding capacity is now used to accommodate error correction data, in order to achieve robustness against transmission or channel errors.

To this end, the embedding arrangement 3 (see FIG. 2) is made robust by comprising an error correction coding circuit 35, which produces parity bits p. The number of parity bits required to correct d×K errors in a segment is h(d) bits per symbol, where we have assumed a symmetric channel with transition parameter d. For example, if d=0.05, then h(d)=0.2864 parity bits per symbol are to be embedded.

The remaining embedding capacity is used for embedding auxiliary data or payload w. In the present example, 0.3786−0.2864=0.0922 payload bits w per symbol can be embedded. The restoration data r, parity bits p, and payload w are concatenated in a concatenation circuit 35. It is the concatenated data d which is applied to the embedder 31 for embedding.

More generally, the inventors have formulated the following therorem. Let D be a data-hiding method for block length K with average distortion Dₐᵥ=Δ and rate ρ. View D as a (not necessarily memoryless) test channel from sequences x₁^{N} to sequences y₁^{N}. Let C be the recursive construction of the above. Then C(D) is a reversible data-hiding scheme with average distortion Δ and rate ρ−H(X₁^{K}|Y₁^{K})/K−h(d).

The reversible embedding arrangement disclosed in the Kalker et al. prior art publication, is recursive. This is understood to mean that the concatenation circuit 35 applies the restoration data r to embedder 31 with a one-segment delay. The restoration data for a segment is thus embedded in the subsequent segment. In accordance with a preferred embodiment of this invention, the concatenation circuit 35 also applies the error correction data p of a segment to embedder 31 with a delay, preferably the same one-segment delay. The error correction data for a segment is thus also embedded in the subsequent segment. As will be appreciated with reference to FIG. 2, this has the advantage that the error correction data p can be processed in a manner similar to and compatible with the restoration data r. The robust recursive reversible data embedding arrangement 3 thus has a non-complicated (hardware or software) structure.

Two practical examples of particular methods of embedding the restoration data r and parity data p in a subsequent segment will now be described. In the examples, it will be assumed that embedder 31 is of a type as described above with block length 3. In accordance with equations (2) and (3), the distortion of this non-robust and non-reversible embedder 31 is D=¼ and the embedding rate is R=⅔ bits/symbol. It will further be assumed, as before, that the host signal has symbol probability p₀=0.9, and channel 4 has transition probability d=0.05.

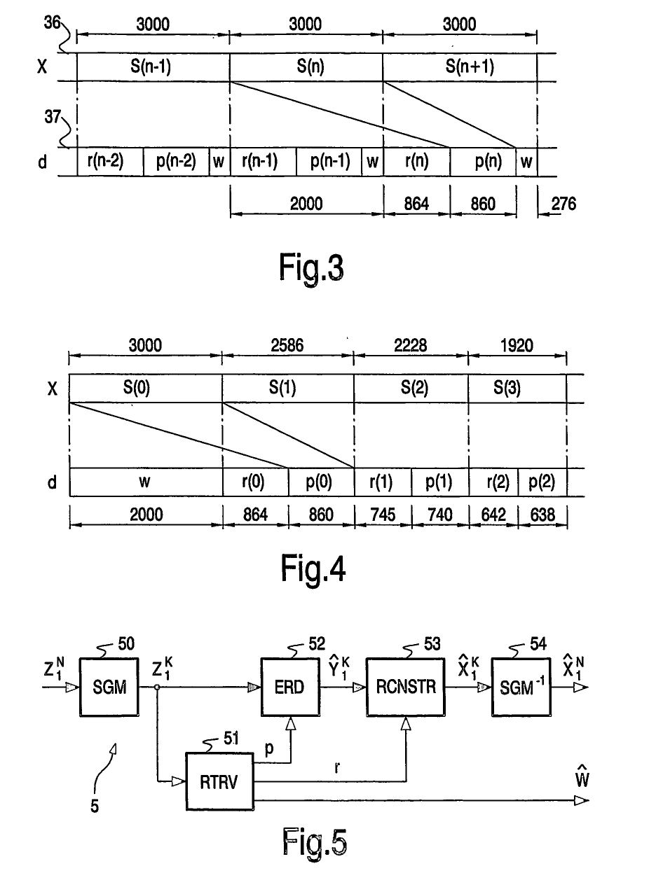

In the first example, the host signal is divided in equal length segments S(n) of K=3000 symbols (bits). This is illustrated by reference numeral 36 in FIG. 3. Reference numeral 37 in this Fig. denotes the embedded data d. The embedding rate is R=⅔ bits/symbol, so 2000 bits can be embedded in each segment. As calculated before, 0.8642 restoration bits r per block (0.288 bits/symbol, 864 bits per segment) are required to reconstruct a segment X given segment Y. As shown in the Fig., the restoration bits r(n) associated with segment S(n) are embedded in subsequent segment S(n+1), whereas the restoration bits embedded in segment S(n) are the restoration bits r(n−1) for reconstructing the previous segment S(n−1). Note that the numbers are statistically average numbers. The precise number of restoration bits may vary from segment to segment. It is advantageous to identify the boundary between restoration bits r and the rest of the embedded data, for example, by providing each series of restoration bits with an appropriate end-code.

As also shown before, 0.2864 parity bits per symbol (860 bits per segment) are to be embedded for error correction. The parity bits associated with segment S(n) are denoted p(n). FIG. 3 shows that they are also embedded in the subsequent segment S(n+1). This leaves, on average, 2000−864−860=276 bits per segment for embedding payload w. The embedding rate of the robust recursive reversible embedder is thus 276 bits per 3000 symbols, which corresponds to 0.0922 bits/symbol as already mentioned before.

Note that, in this embodiment, the first and last segment of a sequence must be processed differently. In the first segment, payload data w only can be embedded. In the last segment, the afore mentioned “simple” embedding method can be used to accommodate restoration data r as well as error correction data p relating to said last segment.

FIG. 4 shows a second example of segmenting the host signal X. In this embodiment, an initial segment S(0) with a given initial length is provided with payload w only. The restoration bits r(0) and parity bits p(0) for this segment are accommodated in subsequent segment S(1). The subsequent segment S(1) is now assigned a length that is required to accommodate the restoration bits r(0) and parity bits p(0). In turn, the subsequent segment S(1) requires a new number of restoration bits r(1) and parity bits p(1) to be embedded in a yet further segment S(2), etc. This process is repeated a number of times, e.g. until the subsequent segment is smaller than a given threshold. No payload w is embedded in the subsequent segments. The whole process is then repeated for a new initial segment S(0) with the given initial length.

FIG. 5 shows a schematic diagram of an arrangement for reconstructing the original host signal from a received composite signal. The arrangement receives the sequence Z₁^{N} from attack channel 4 (cf. FIG. 1). A segmentation circuit 50 divides the sequence in segments Z₁^{K} of length K. The segments Z₁^{K} are applied to a data retrieval circuit 51 and an error detection an correction circuit 52 in reversed order.

The data retrieval circuit 51 retrieves the data d being embedded in the composite signal. In the preferred embodiment, wherein de data d has been embedded using Hamming codes of length L, the retrieval circuit 51 determines the syndrome of each block of L symbols. The circuit also splits the retrieved data into error correction data p, restoration data r, and auxiliary payload w.

The error correction data p is applied to the error detection an correction circuit 52 to correct errors in the segment Z₁^{K}. Its output is an estimated composite signal segment Ŷ₁^{K}. A reconstruction unit 53 is arranged to undo the modification(s) applied to the original host signal X₁^{K}, using the retrieved restoration data r. In the preferred embodiment, the restoration data r identifies whether one of the symbols in a segment Y₁^{K} has been modified and, if so, which symbol that is. The restoration is applied to the estimated composite signal segment Ŷ₁^{K}, yielding an estimation \hat{X}₁^{K} of the orignal host signal segment X₁^{K}. Due to the embedded error correction data, the reconsruction is perfect, even in the case of bit errors caused by the attack channel. The reconstructed host signal segments \hat{X}₁^{K} are finally re-ordered and desegmented in a desegmentation circuit 54.

1. A method of embedding auxiliary data in a host signal, comprising the steps of:
using a data embedding method having an embedding rate and distortion to produce a composite signal;
using a first portion of said embedding rate to accommodate restoration data for restoring the host signal and a second portion of said embedding rate for embedding said auxiliary data;
characterized in that the method comprises the step of using a third portion of said embedding rate for embedding error correcting data to correct errors in said restoration data and/or auxiliary data.

2. A method of embedding auxiliary data in a host signal, comprising the steps of:
segmenting the host signal;
using a predetermined data embedding method having a given embedding rate and distortion for embedding data in a host signal segment, to produce a respective composite signal segment;
determining restoration data identifying the host signal segment conditioned on the composite signal segment; and
embedding said restoration data in a subsequent host signal segment using a portion of the embedding rate;
characterized in that the method further comprises the step of:
generating error correction data for correcting errors in the composite signal segment;
embedding said error correction data in the subsequent host signal segment using a further portion of the embedding rate; and
embedding auxiliary data in a host signal segment using the remaining portion of the embedding rate.

3. A method as claimed in claim 2, wherein each segment comprises the restoration data and error correction data for a previous segment as well as auxiliary data.

4. A method as claimed in claim 3, wherein the segments have equal lengths.

5. A method as claimed in claim 2, comprising the steps of:
(a) embedding auxiliary data only in a first host signal segment having a given length;
(b) embedding, in a subsequent segment, the restoration data and error correction data for the previous segment;
(c) adapting the length of said subsequent segment to the amount of said restoration data and error correction data; and
(d) repeating steps (b) and (c) until the length of the subsequent segment is smaller than a given threshold.

6. An arrangement for embedding auxiliary data in a host signal, comprising:
segmentation means for segmenting the host signal;
a predetermined data embedder having a given embedding rate and distortion for embedding data in a host signal segment, to produce a respective composite signal segment;
means for determining restoration data identifying the host signal segment conditioned on the composite signal segment; and
the data embedder being arranged to embed said restoration data in a subsequent host signal segment using a portion of the embedding rate;
characterized in that the arrangement further comprises means for generating error correction data for correcting errors in the composite signal segment, the data embedder further being arranged to embed said error correction data in the subsequent host signal segment using a further portion of the embedding rate, and to embed auxiliary data in a host signal segment using the remaining portion of the embedding rate.

7. A method of reconstructing a host signal from a composite signal produced by a method as claimed in claim 2, comprising the steps of:
segmenting said composite signal;
retrieving from a composite signal segment the error correction data embedded therein;
using said error correction data to correct errors in a previous composite signal segment;
retrieving from the composite signal segment restoration data embedded therein; and
using said restoration data to reconstruct the previous host signal segment given the previous composite signal segment.

8. An arrangement for reconstructing a host signal from a composite signal produced by a method as claimed in claim 2, comprising:
segmentation means for segmenting said composite signal;
means for retrieving from a composite signal segment the error correction data embedded therein;
errr correction means for correcting errors in a previous composite signal segment using said error correction data;
means for retrieving from the composite signal segment restoration data embedded therein; and
reconstructing the previous host signal segment given the previous composite signal segment, using said restoration data.

9. A composite information signal in the form of segments with embedded data, the data embedded in a composition signal segment comprising restoration data identifying a previous host signal segment conditioned on the corresponding previous composite signal segment, and further comprising error correction data for correcting errors in said previous composite signal segment.
